(19) United States
(12) Patent Application Publication
(10) Pub. No.: US 2004/0107181 A1
(43) Pub. Date: Jun. 3, 2004

(54) System and method for capturing, storing, organizing and sharing visual, audio and sensory experience and event records

(75) Inventor: Patrick T. Rodden, Clinton, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: FIORI Product Development, Inc., Bothell, WA (US)

(21) Appl. No.: 10/713,998

(22) Filed: Nov. 14, 2003

Related U.S. Application Data
(60) Provisional application No. 60/426,200, filed on Nov. 14, 2002.

(51) Int. Cl. G06F 7/00

(52) U.S. Cl. 707/1

(57) ABSTRACT

Multimedia data elements may be captured in the form of image data, audio data, textual data, and the like. Universal time and date stamps are associated with the acquisition of the various data elements to create a contextual reference. The data elements and contextual references are stored in a storage area, such as a database. A relational database may allow convenient storage and retrieval of data elements based on user-entered contextual search elements. In one embodiment, data input devices may be miniaturized and wearable by one or more users. Data may be collected manually or automatically with each data element having universal data, such as time, date and position associated therewith. Multiple users may each have a database and permission may be granted to view other databases or to alter other databases to thereby exchange data elements. Data elements may be retrieved based on search elements, such as the contextual references.

### BACKGROUND OF THE INVENTION

1. Field of the Invention

The present invention is directed generally to biographical information and, more particularly, to a system and method for recording biographical experience information.

2. Description of the Related Art

History is replete with examples of storytelling. The earliest examples of storytelling took the form of artwork, such as cave paintings. After the development of writing, authors created written works. Herodotus, sometimes referred to as the ‘father of history,’ was an early Greek writer who described the Peloponnesian war. Subsequent written works have included biographies and autobiographies to describe a person's life, or some aspect thereof, in a written form.

The introduction of photography added a new dimension to storytelling. Authors and artists, including photographers, have worked in their selected medium to describe people, lives, experiences in an attempt to capture life's essence through storytelling. Recent changes in technology have greatly increased the opportunities for individual storytelling. Improvements in technology, such as computers, word processing devices, digital cameras, video recording devices, and the like provide vast new opportunities for depicting life's essence and for storytelling. The use of other information sources, such as the Internet, allow almost instant access to vast amounts of information.

Despite the introduction of these incredible new technologies, storytelling, particularly recording one's own life story, has changed little over the years. Individuals may still write in journals, either handwritten or on computer, to record their own thoughts and describe events. However, such individual storytelling tends to be a collection of discrete items. For example, many photographs tend to end up as a collection of discrete unrelated images stored in a shoe box. Such information has little or no context with which one can capture their own life's story. Accordingly, it can be appreciated that there is a significant need for techniques that will permit the combination of words and images with a form of pervasive context that will simplify the telling of one's life story. The present invention provides this, and other advantages as will be apparent from the following detailed description and accompanying figures.

### BRIEF SUMMARY OF THE INVENTION

The present invention is directed to techniques for integrating contextual data to accompany captured data elements. In one embodiment, a context-based data collection system comprises a clock to provide a time context, a first data input device to capture a first data element, and a second data input device to capture a second data element. A processor associates each of the first and second captured data elements with a respective time context and a data storage element stores the first and second data elements in association with the time context wherein the first and second data elements are stored in the data storage element in association with each other based on the time context.

In one embodiment, the data storage element is a relational database, and the first and second data elements are stored in the database in relation to each other.

The system may also include an input device to generate text data wherein the first and second data elements are stored in the data storage element in relation to each other based on the text data. The clock may also provide a date data context wherein the first and second data elements are stored in the data storage element in association with each other based on the date context. In yet another embodiment, the system further comprises a position determination unit to provide position contexts wherein the first and second data elements are stored in the data storage element in association with each other based on the position context. In one embodiment, the position determination unit may comprise a global positioning system (GPS) receiver. The GPS receiver may further provide time information wherein the clock utilizes the time information to establish a time of day used to provide the time context.

In one embodiment, the first and second data input devices may be image input devices and the first and second data elements are images. The image input device may be a photographic camera, a video camera, or a scanner to provide a scanned image.

In an alternative embodiment, the first and second data input devices are audio input devices and the first and second data elements are audio data.

The data element collection may be automatically triggered. In one embodiment, the trigger is periodically activated and, in an alternative embodiment, the trigger is activated by an event external to the system.

Portions of the system may be implemented in miniature form to permit wearable input devices. In this embodiment, at least the first data input device is configured to be worn by an individual user.

The system may also be utilized with a second system, each system having a clock, first and second data input devices, a processor and a data storage element. The system further comprises a communication controller to control communication between the systems with the communication controller permitting access to the data storage element of the other system to thereby exchange data storage elements between the systems. In one embodiment, the two systems exchange data storage elements between the systems based on the time context associated with the stored data elements.

In another aspect, the invention is embodied in a relational database system comprising a storage device to store data elements and an input interface to receive a plurality of multimedia data elements. Each of the plurality of multimedia data elements has a time context, a date context, and a place context associated therewith. The input interface stores the plurality of multimedia data elements in the storage device in association with time, date and place contexts. The relational database system also includes a search interface configured to receive a search element and to locate all multimedia data elements within the storage device that match the search element. An output interface generates an output list of all multimedia data elements that match the search element.

### BRIEF DESCRIPTION OF THE SEVERAL VIEWS OF THE DRAWING(S)

FIG. 1 is an illustration of an individual and frames of reference that add context and perspective to the individual's life experience.

FIG. 2 is an illustration of the operation of the present system to integrate various data elements and contextual references to establish an integrated experience.

FIG. 3 illustrates spontaneous and staged collection devices that may be used to capture data elements representative of life experiences.

FIG. 4 is an illustration of a display of images and other data associated with a life experience at a selected point in time.

FIG. 5 illustrates a connection between multiple life experience records.

FIG. 6 illustrates a greatly expanded network of life experience records.

FIG. 7 is a functional block diagram of a system used to implement one embodiment of the present invention.

FIG. 8 illustrates a user-wearable data collection device.

FIG. 9 illustrates a technique for correcting variations in collected image data.

FIG. 10 is a flowchart illustrating the operation of the system of FIG. 7 to acquire and store data elements.

FIG. 11 is a flowchart illustrating the operation of the system of FIG. 7 to search and retrieve stored data elements.

FIG. 12 is a functional block diagram illustrating the operation of multiple systems across a network to share collective life experiences.

### DETAILED DESCRIPTION OF THE INVENTION

As will be discussed in greater detail herein, a system constructed in accordance with the present teachings allows images and other data to be captured in a way that provides context and perspective. It is this integration of context and perspective along with other discrete data that provides a more complete picture of one's life. For example, photographs of a birthday party are often simply a discrete package of pictures that, in years to come, are often undated and stored in a box such that all context and perspective is lost. Similarly, vacation photographs also lose meaning with the passage of time and become a disconnected collection of discrete images.

In contrast, the system described herein allows the capture of contextual information that may serve to integrate the images into a meaningful story. Thus, birthday party photographs become part of a life story. Vacation photographs may depict a meaningful summer in one's life.

FIG. 1 illustrates an example of the context and perspective that may be added to data related to an individual. As illustrated in FIG. 1, the individual may be depicted within the context of a family and friends. The context and perspective of the individual may be further expanded to include work and other interests, community, as well as the culture of the individual and other related contextual elements. The context and perspective may further be expanded to include the region, country and world. Thus, data elements related to the individual may be placed in much broader context and perspective. As will be described in greater detail below, a variety of different data elements may be related to the individual. These data elements may be in the form of image data, audio data, time, date, location, and the like. For the sake of simplicity, these various elements are referred to herein as data elements.

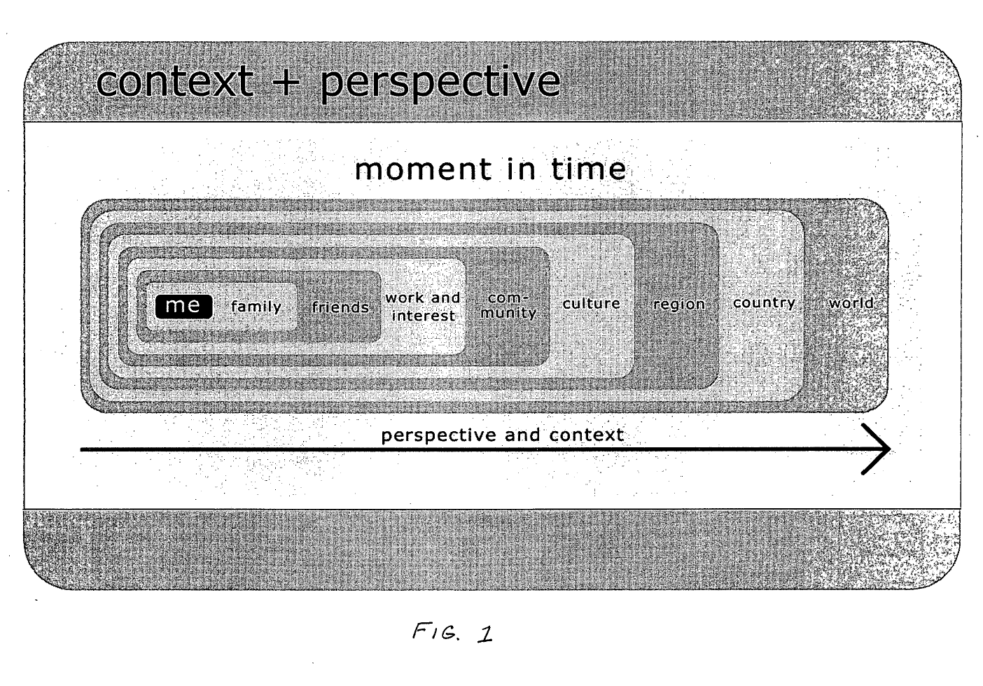

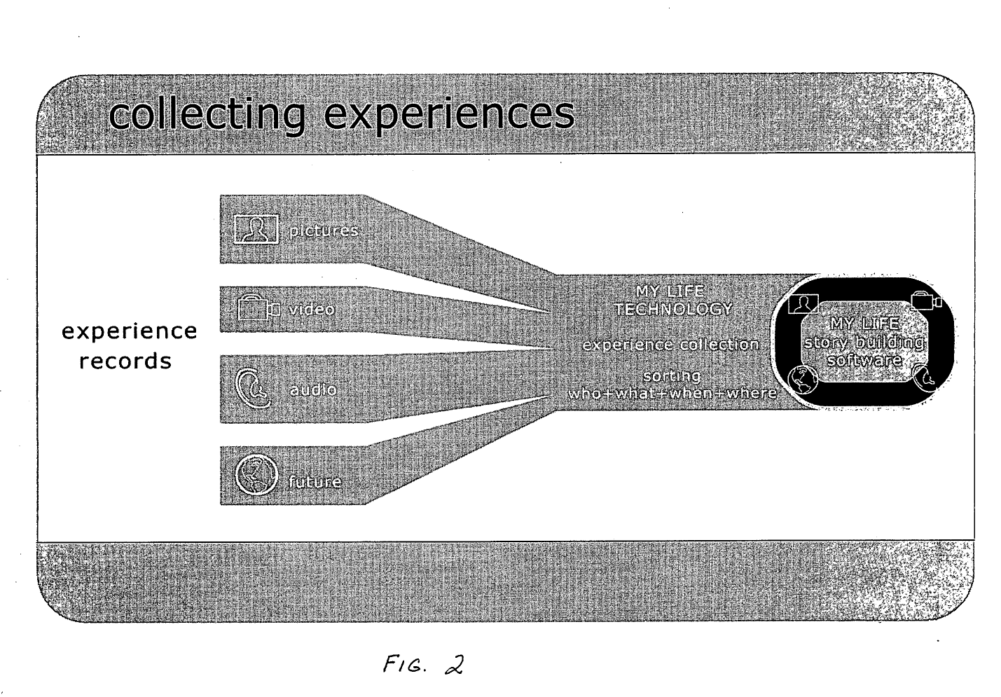

FIG. 2 illustrates the integration of the various experiences. The various elements may be collected and stored in a variety of different manners, which will be described in greater detail below. Most images collected in accordance with known technologies tend to be staged events. For example, photographs of a birthday party may be hastily taken but are nonetheless staged events in the sense that an individual pointed the camera at the desired object and exposed the film. Other examples of such staged events may be journal entries, descriptions of appointments, events and the like. In accordance with the description herein, data elements may include a staged collection, such as photographs, journal entries and the like. In addition, data elements may include a spontaneous collection of data elements.

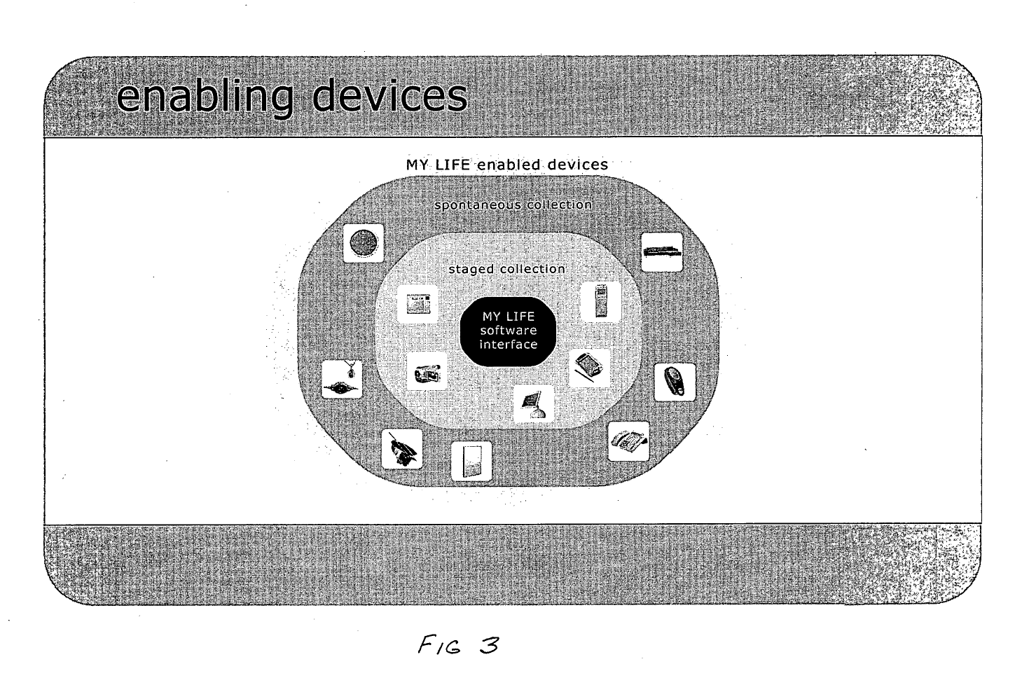

FIG. 3 illustrates an example of various enabled devices that comprise a staged collection and a spontaneous collection. Each of these items may provide data elements that can be integrated and stored as part of one's life experience. The items illustrated in FIG. 3 are intended to illustrate the variety of items that may serve as a source for data elements.

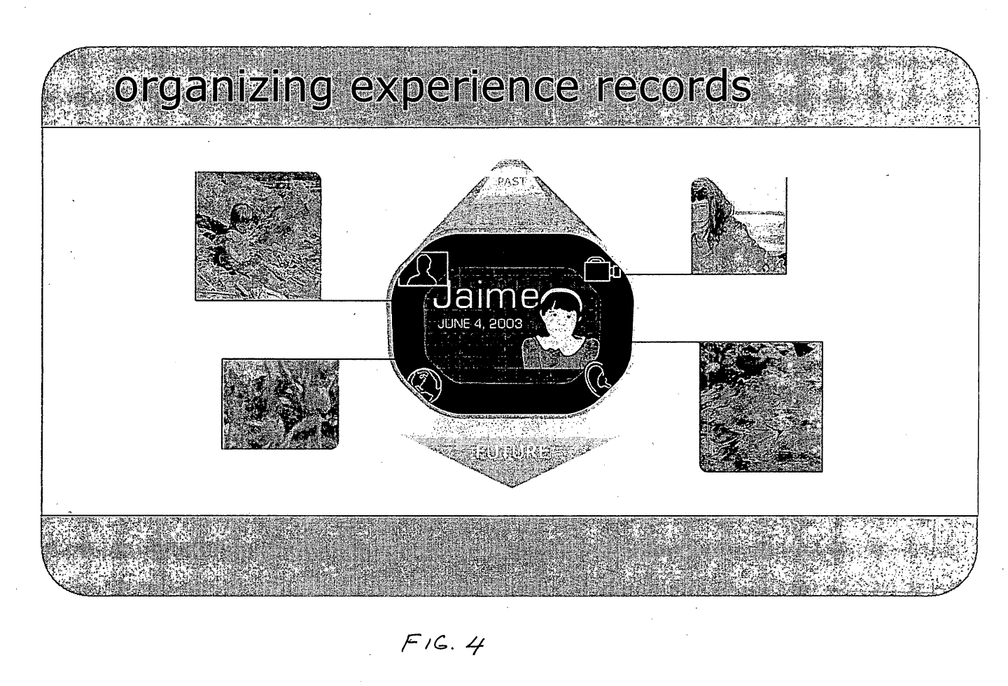

FIG. 4 graphically illustrates a data storage technique that may be used to store and retrieve experience records. An individual name and date are shown on the central portion of a screen display on a computer surrounded by various computer-generated icons that are related to data elements associated with that point in time. The icons are representative of various possible data elements. The snapshot icon in the upper left serves to indicate that one or more snapshots are available for that day. The user can activate the display of additional snapshots by selecting the snapshot icon in a conventional manner. The recorder icon in the upper right indicates that video images are available for that day. Available video data element can be displayed by selecting the recorder icon. An auditory icon indicates the availability of audio data elements for that day. The available audio data elements may be played via a conventional computer sound system (not shown) by selecting the auditory icon. Those skilled in the art will recognize that the audio data elements may include audio recordings made by the user, such as conversations, environmental sounds and the like. Audio data elements may also comprise pre-recorded sounds, such as television or radio sound segments. There is virtually no limit to the sources of audio data elements that help provide context and meaning to one's life experience.

The globe icon in the lower left indicates that other contextual data may be available that helps describe the individual's “world” on the selected day. The world data elements may be displayed by selecting the globe icon. These data elements may provide information about other persons in the individual's world, school or work events, or local, regional, national or international events. The source and nature of the data element is virtually unlimited. For example, one particular day may have special importance because of the individual's activity at school (e.g., the school play) while another day may have data elements reflecting global significance in the individual's life (e.g., the fall of the Berlin wall may have occurred on the day an individual was born). These world events also provide the desired contextual setting.

Also graphically illustrated in FIG. 4 is a past area and a future area, which relate life experiences relative to the date indicated. For example, an individual wishing to review a past life experience record may manipulate a computer cursor controller, such as a mouse, to move to past records for that individual. Further details of record and data element storage are provided below.

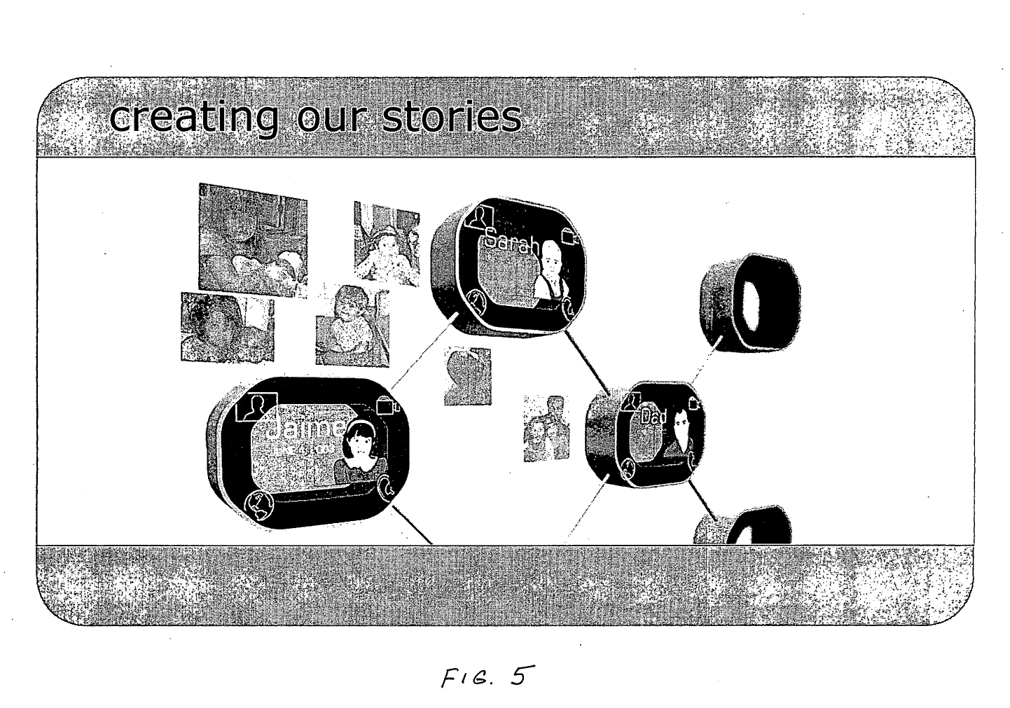

The techniques described herein further permit the creation of the story of an individual with respect to the stories of other individuals. FIG. 5 illustrates such a concept in which family members are interrelated. It is possible to review the life experience records of multiple individuals within a family simply by positioning a cursor on an icon for the desired individual. FIG. 5 graphically illustrates the interrelationship of individuals.

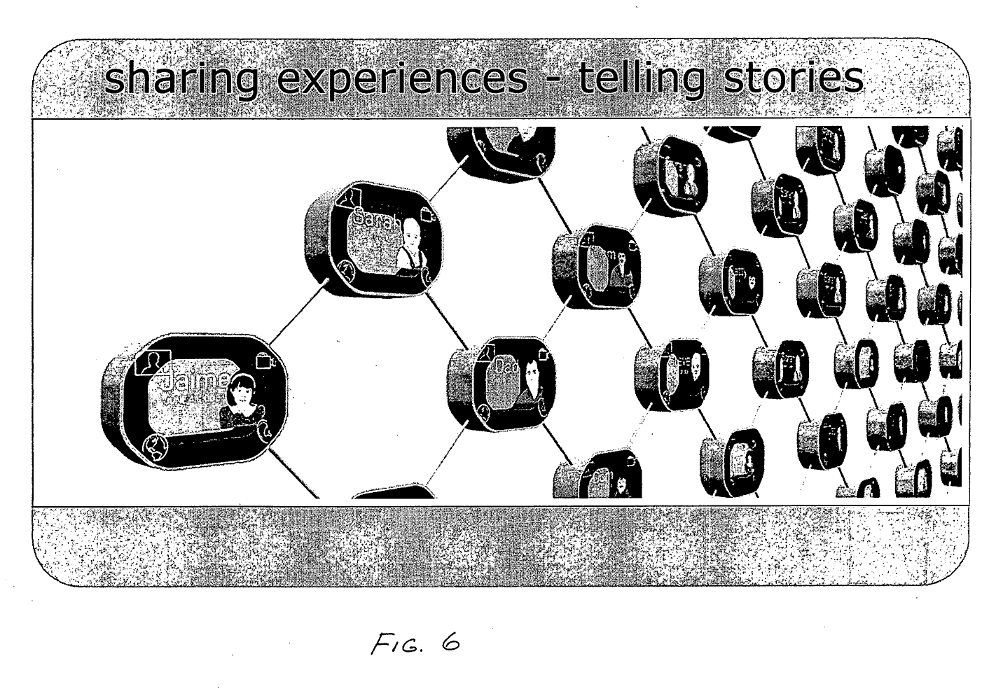

In a larger setting, it is possible to share life experiences in a unique form of storytelling. FIG. 6 illustrates an enlarged network of individuals whose life experiences may be shared. Each individual may be thought of as a node on a network. The network may be as small as an individual or family, or may be enlarged to include extended family, neighbors, friends, community, and the like. Such expansion could be virtually unlimited.

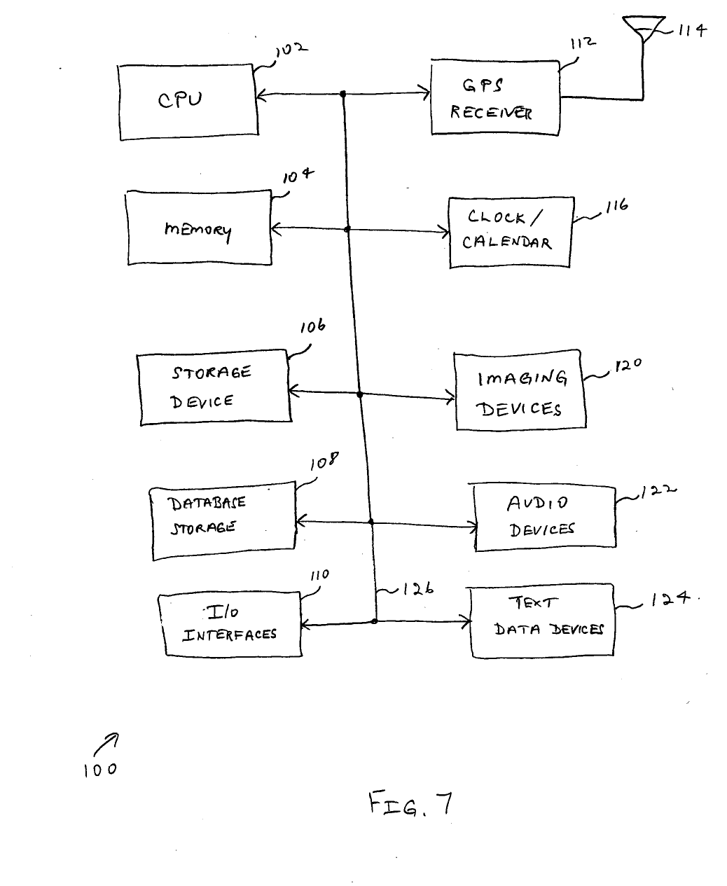

In one embodiment, the present invention is implemented as a system 100 illustrated in the functional block diagram of FIG. 7. Many of the components illustrated in FIG. 7 are readily implemented in a conventional computer, such as a personal computer (PC). The system 100 includes a central processing unit (CPU) 102 and a memory 104. The memory 104 provides data and instructions for processing by the CPU 102. The CPU 102 may be implemented by any number of known computing devices, such as a microprocessor, microcontroller, or the like. To process data and images, the CPU 102 may further comprise a digital signal processor (DSP) or similar device. The system 100 is not limited by the specific implementation of the CPU 102. Similarly, the memory 104 may be implemented by any of a number of known technologies. The memory 104 may include read-only memory, random access memory (RAM), flash memory, memory sticks, or the like. The system 100 is not limited by the specific form or implementation of the memory 104.

The system 100 may also include a storage device 106. Although data elements (e.g., imaged data) may be stored in the memory 104, the storage device 106 may be implemented in the form of a hard disk drive, optical drive, or the like to provide greater storage capacity. The storage device 106 is intended to include one or more known storage technologies. For example, the storage device 106 may comprise a hard disk drive as well as an optical disk drive. Known optical storage technologies include, by way of example, a CD-RNV drive, DVD drive, DVD-RNI drive, or the like. Other known forms of storage device 106 include magnetic storage tapes. The system 100 is not limited by the specific form of the storage device 106.

The system 100 may also include a database storage 108 to assist in organizational storage of the various data elements. The use of database technology is well known in the art and need only be described briefly herein. The database storage 108 may, by way of example, store various data elements in a relational database. Such a relational database allows the extraction of multiple-related data elements. For example, a user may wish to review a past life experience, such as a memorable summer vacation. Entering a search term, such as a date range, will extract all data elements associated with that summer vacation. In another example, an individual may wish to review life experiences associated with another family member or close personal friend. Entering a search element, such as the name of the individual of interest will extract all data elements associated with that named individual. Thus, the database storage 108 provides a data organizational and data extraction technique.

As will be described in greater detail below, the system 100 is intended to function with a number of different external devices. Accordingly, the system 100 includes input/output (I/O) interfaces 110. The specific form of the I/O interfaces 110 may vary depending on the implementation of the system 100. For example, the I/O interfaces 110 may include an Ethernet connection, universal serial bus (USB) interface, or the like. The IO interfaces 110 allow various data elements to be imported into the system.

In addition, the I/O interfaces 110 may allow the export of data elements to share life experiences with other individuals. For example, an individual family member may export data elements from a family outing to other family members for importation into their life experience systems.

One contextual element of life experiences is location. For example, the location at which data elements are collected helps them provide a contextual setting for those images. To assist in location determination, the system 100 may include a GPS receiver 112, which is coupled to a GPS antenna 114. The operation of the GPS receiver 112 is well known in the art and need only be described in relation to the system 100. In one implementation, the GPS receiver 112 is activated to provide position data whenever a data element is collected. The data element may include, by way of example, image data, such as video data or a photograph, written data, such as a journal entry, audio data, or the like. As those skilled in the art can appreciate, the position data adds a contextual element to the other data elements collected by the system 100.

The system 100 also includes a clock/calendar 116 to provide a time and date reference for the collection of data elements. The clock/calendar 116 may operate in conjunction with the GPS receiver 112. That is, the GPS receiver 112 may provide synchronization data to the clock/calendar 116 to thereby permit the clock to maintain an accurate time base. In an exemplary embodiment, the clock/calendar 116 is set to Greenwich Mean Time (GMT) and provides the time and date at which other data elements are provided to the system 100. Those skilled in the art will appreciate that the time and date are yet another contextual element provided by the system 100.

The system 100 further comprises a number of devices to provide data elements to the system 100. This includes imaging devices 120, audio devices 122, and text data devices 124. The imaging devices 120 may comprise still images, such as digital photographs, scanned analog photographs, or the like. The imaging devices 120 may also include video or film images. In an exemplary embodiment, discussed in greater detail below, an imaging device may be worn by the individual to generate a spontaneous collection of data elements. In one embodiment, the imaging device worn by the individual may collect still images in the form of periodic digital photographs or may collect video images.

The audio devices 122 provide the system with the ability to collect recorded voices, music, environmental sounds, and the like. For example, the collection of image data elements by the imaging devices 120 may be accompanied by a collection of audio data elements collected by the audio devices 122 to provide a contextual relationship between audio and image data elements. In one example, a life experience resulting from a summer vacation may include images of the summer vacation as well as accompanying audio data. The audio data may be in the form of voices of family members participating in the vacation or may include environmental sounds to further provide a contextual basis for the life experience. In yet another example, the audio samples may comprise one or more songs heard on the radio during the vacation or seen live by the individual during the summer vacation. These various contextual data elements serve to integrate the life experiences of the individual.

The text data devices 124 may comprise a keyboard to provide the system 100 with text data, word processing files, spreadsheet data, contact information (e.g., names, telephone numbers, email addresses, etc.), and the like. Word processing files may include such items as journal entries, commentary on specific imaging data elements and/or audio data elements, or other descriptive material. Other text data devices, such as a personal digital assistant (PDA) may provide contact information, appointment data or the like. The text data devices 124 provide additional data elements that further provide an integrated recordation of a life experience.

The Internet (see FIG. 12) may also serve as a source of data elements in the form of image data, audio data, and text data. This allows the user to enter information about other events that may help put a particular day or event in perspective. These various data elements are stored in the database storage 108 in association with the various contextual elements, such as time, date, and place. The data elements may also be associated with an icon, such as the icons of FIG. 4 so that audio data elements are associated with the auditory icon.

The various components described above are coupled together by a bus system 126. Those skilled in the art will appreciate that the bus system 126 may comprise a number of different busses, such as data bus, power bus, address bus, control bus, and the like. For the sake of simplicity, those various busses are illustrated in the functional block diagram of FIG. 7 as the bus system 126.

Those skilled in the art will recognize that some of the blocks illustrated in the functional block diagram of FIG. 7 may be implemented as a set of computer instructions stored in the memory 104 and executed by the CPU 102. For example, the database storage 108 may be a software program executed by the CPU 102 where the database storage 108 may be part of the memory 104 or stored in the data storage 106. However, because the database storage 108 performs a separate function, it is illustrated as a separate component in the functional block diagram of FIG. 7.

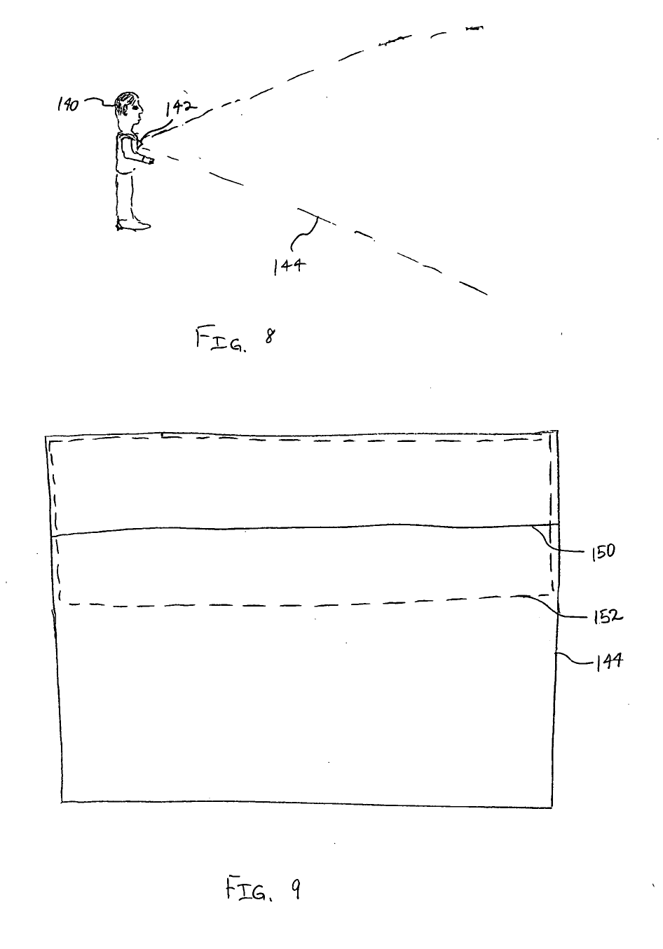

FIG. 8 illustrates a subject 140 having a portable input device 142 in the form of a wearable item. The portable input device 142 is illustrated in FIG. 8 as attached to a shirt or jacket of the subject 140. However, the portable input device 142 may readily be incorporated in other items, such as a belt buckle, pendant, hat, cellular phone, or the like. The portable input device 142 may comprise an imaging device 120 and/or an audio device 122.

The portable input device 142 acquires data elements (e.g., image data and/or audio data) automatically based on a set of predefined conditions, such as the trigger of a sound, a certain time period, certain forms of detected motion, or the like. Alternatively, the portable input device 142 may be manually triggered to acquire a data element much in the manner that a camera would be triggered to capture a single “snapshot.” Each time the portable input device 142 captures a data element, it also acquires position data and time/date data. The position data may be provided by the GPS receiver 112 in the manner described above. The time/date data may be provided by the clock/calendar 116 in the manner described above. These contextual data elements (e.g., time, date and place) are stored in the storage device 106 in association with each other. Thus, the experience of the subject 140 is captured by the system 100 and stored. This experience may be reviewed by the subject 140 or by any other individual having access to the experience data elements in the storage device 106.

In one embodiment, the imaging device 120 of the portable input device 142 may include a wide-angle or spherical lens to capture wide angle or spherical views of an image. FIG. 8 illustrates a field view 144 that may be captured by the imaging device 120 of the portable input device 142.

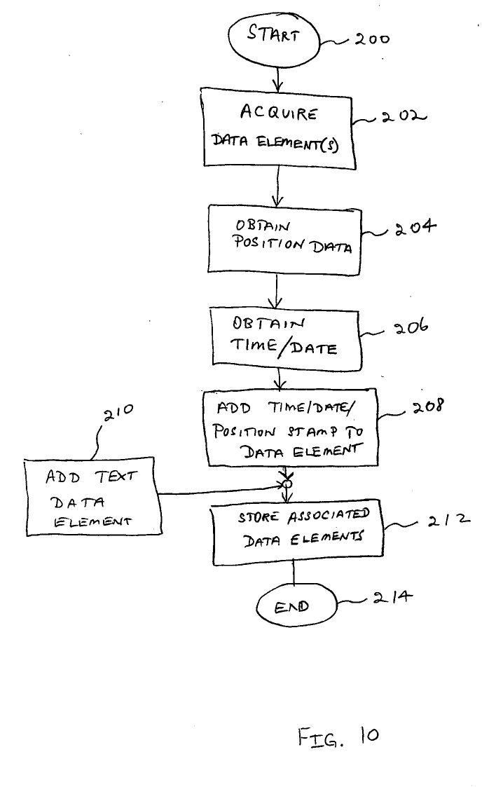

The system 100 may further provide automatic horizon sensing such that images are captured in a desirable frame relationship with respect to the ground. FIG. 9 illustrates an image showing the entire field view 144 and a horizon 150 within the field view 144. As illustrated in FIG. 9, the horizon 150 is high in the image, thus showing a disproportionate amount of the ground in front of the subject 140. The system 100 may automatically create an adjusted frame 152 to maintain a predetermined desired position of the horizon 150 within the frame. In an exemplary embodiment, the adjusted frame 152 may be scaled to a size equivalent to the original field view 144.

The data elements captured by the portable input device 142 may be temporarily stored within the portable input device and subsequently downloaded into a larger computer, such as that illustrated in FIG. 7. In this embodiment, the portable input device 142 may not include the storage device 106 but may store collected data elements (e.g., image data elements, audio data elements, time and date data elements, and place data elements) within the memory 104. Conventional memory devices, such as a memory stick, may be used as part of the portable input device 142. The memory stick or other memory device may be coupled to the appropriate I/O interface 110 for downloading into the storage device 106 or for subsequent storage in the database storage 108.

In yet another alternative embodiment, portable input devices 142 are placed in locations such as an automobile or throughout the home. Web cameras are known in the art. However a web camera could be modified to comprise an imaging device 120 and/or an audio device 122 and operate in conjunction with the GPS receiver 112 and the clock/calendar 116 to provide the time, date and place contextual data elements whenever a data element (e.g., an image data element or an audio data element) is captured. The input device 142 acquires data elements (e.g., image data and/or audio data) automatically based on a set of predefined conditions, such as the trigger of a sound, a certain time period, certain forms of detected motion, or the like. The portable input device 142 could be incorporated into everyday household objects to create a more decorative experience. For example, the portable input device 142 could be placed in a clock, a television or other household device to blend in with a selected home decor.

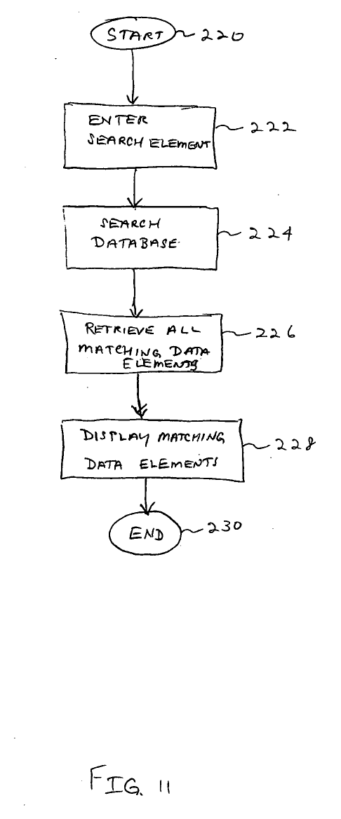

FIG. 10 is a flowchart illustrating the operation of the system 100. At a start 200, the system 100 is under power and, at step 202, acquires one or more data elements. As noted above, data elements are intended to include image data elements, audio data elements, and/or text data elements.

At Step 204, the system obtains a position data element. As noted above, the GPS receiver 112 (see FIG. 7) can automatically provide the desired position data element. Alternatively, the user (e.g., the individual 140 of FIG. 8) may manually enter position data via a keyboard or other conventional computer input device (not shown). Certain cell phones have built-in imaging deices that may be used to provide an image data element. Certain cell phones also have position determination ability in the form of an integrated GPS receiver or using network-assisted position determining capability in a known manner to derive position contextual data elements when an image is generated. The cell phone also has a clock to provide the time and date contextual data elements.

At step 206, the system 100 obtains time and date data elements. As noted above, the time and date data elements may be automatically provided by the clock/calendar 116 or the portable input device 142 may supply time and date. Alternatively, the user may manually enter the time and date using known input devices in the manner described above with respect to manual entry of position data.

At step 208, the system 100 adds a time/date/position stamp to the acquired data element. Those skilled in the art will appreciate that adding such a “stamp” may comprise storing such data in a predetermined data field within the storage device 106 or the database storage 108 and associating it with the stored required data element. However, the time/date/position stamp may also involve simply storing these data elements in the database storage in association with the data elements acquired in step 202. For example, a relational database implementation of the database storage 108 may allow these various data elements to be entered in association with the time/date/position stamp. At a subsequent time, a user may, by way of example, search for the various collective life experiences of a particular time period by querying the database storage 108 for all data elements associated with the user specified time or date range. In another example, a user may wish to recall the various life experiences associated with a particular location (e.g., the family's summer cabin). Such a query to the database storage 108 would result in the retrieval of all data elements associated with the specified location and may include data elements collected over a number of different time periods.

In step 210, the system 100 permits the addition of a text data element to be associated with the acquired data elements. By way of example, the text data element may be news articles about local, regional, national or international news events that help create contextual settings for the acquired data elements. In another example, the text data elements may simply identify the data elements acquired in step 202. For example, the data elements may be image data and the text data provided in step 210 simply identifies the image. Such identification may be an identification of the setting, individuals within the image, or other commentary. For example, the image may be identified as “Our Summer Vacation.”

In step 212, the system 100 stores the various associated data elements. In an exemplary embodiment, the various data elements are stored within the database storage 108, which may be implemented as a relational database. The functionality of a relational database is known in the art and need not be described in great detail herein. However, the advantage of a relational database is that data elements need not be stored in specific locations with respect to one another. Rather, the various data elements are associated with each other. The use of a relational database permits the search and retrieval of data elements based on a number of different search terms. The storage process ends at step 214.

Those skilled in the art will recognize that various data elements may be stored in a variety of data formats. For the sake of simplicity in storage and to reduce the number of different skins required to play back the data elements, it is desired that the similar data elements be stored in the same data format. For example, image data may be stored in the form of a JPEG file while audio data elements may be stored in the form of a WMA data file. This should not be construed as a limitation on the system 100, but merely a convenient technique to reduce the complexity of the system. Conventional data compression techniques may also be used to reduce the storage demands on the system 100.

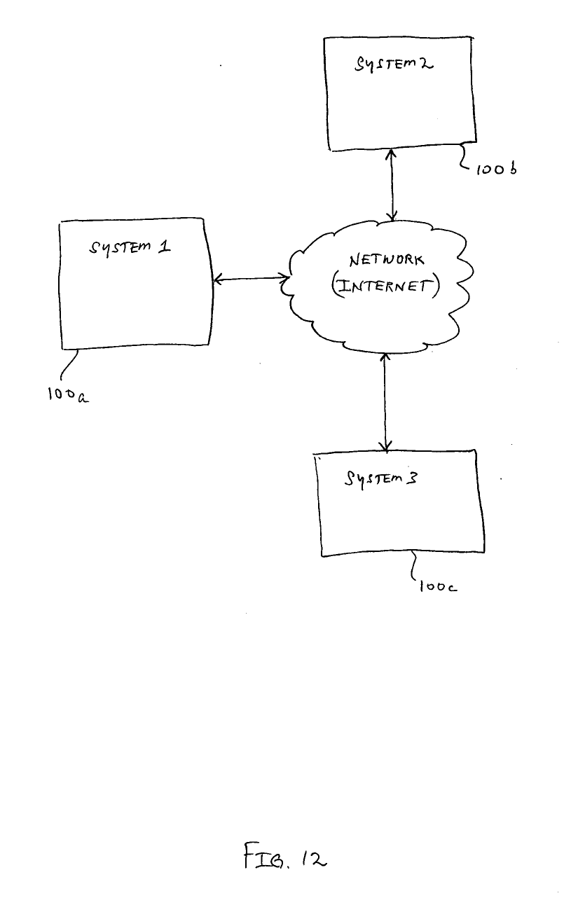

FIG. 11 is a flow chart illustrating the operation of the system 100 to search and retrieve stored data elements. At a start 220, the database storage 108 has a plurality of data elements having contextual association, such as time, date, place and/or text. In step 222, the user enters a search element. The search element may be any text or the various context relationships described above.

In step 224, the system 100 searches the database storage 108 and, in step 226, the system 100 retrieves all matching data elements. The matching data elements are displayed (or played on an audio output system in the event of an audio data element) and the retrieval process ends at step 230.

In an alternative embodiment, certain context data may be entered graphically. FIG. 4 illustrates an organizational technique for displaying experience records and, includes a specified date on a display. By manipulating a cursor control device, the user may move forward or backward in time to display a different date. The selected date shown on a computer display, such as that of FIG. 4, automatically results in the retrieval of all data elements associated with that date. In this manner, the user may scroll back and forth through time to view data elements associated with the selected dates.

FIG. 12 illustrates the operation of multiple ones of the system 100 to exchange collective experiences and thereby broaden one's personal life experience. In FIG. 12, systems 100a-c each are replicated with the elements illustrated in the functional block diagram of FIG. 7. In addition, each of the systems 100a-c has a network interface controller (NIC) that permit the connection of each system to a network, such as the internet. Those skilled in the art will recognize that the specific implementation of the NIC (not shown) may vary from one system to another. For example, the system 100a may have a cable modem connection to the internet. In this embodiment, the NIC for the system 100a would be a cable modem interface. At the same time, the system 100b may have a dial-up connection to the internet. The NIC for the system 100b is a conventional dial-up modem. The system 100 is not limited by the specific form of the connection to the network.

The use of multiple systems coupled via a network broadly expands the capability of exchanging experiences. For example, multiple members of a hiking expedition may have each collected different data elements based on their own experiences. The configuration of FIG. 12 allows those multiple group members to share their experience. The system 100 can utilize conventional network permissions technology to allow one user to search the database of another user. For example, the user of the system 100a may enter search elements to search the database storage of the system 100c. Based on the authorization level, the user of the system 100a may be able to retrieve data elements for storage in his own database storage. With yet another level of permission, the user of the system 100a may be able to alter the database storage of the system 100c by providing additional data elements relevant to the user of the system 100c. In this manner, multiple users can share collective experiences and help build the stored data elements of others.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

The invention claimed is:

1. A context-based data collection system comprising:
a clock to provide a time context;
a first data input device to capture a first data element;
a second data input device to capture a second data element;
a processor to associate each of the first and second captured data elements with a respective time context; and
a data storage element to store the first and second data elements in association with the time context wherein the first and second data elements are stored in the data storage element in association with each other based on the time context.

2. The system of claim 1 wherein the data storage element is a relational database and the first and second data elements are stored in the database in relation to each other.

3. The system of claim 1 wherein the data storage element is a relational database, the system further comprising an input device to generate text data wherein data storage element stores the first and second data elements are stored in the data storage element in relation to each other based on the text data.

4. The system of claim 1 wherein the clock provides a date data context and wherein data storage element stores the first and second data elements are stored in the data storage element in association with each other based on the date context.

5. The system of claim 1, further comprising a position determination unit to provide a position context wherein data storage element stores the first and second data elements in association with each other based on the position context.

6. The system of claim 5 wherein the position determination unit comprises a global positioning system (GPS) receiver.

7. The system of claim 6 wherein the GPS receiver provides time information and the clock utilizes the time information to establish a time of day used to provide the time context.

8. The system of claim 1 wherein the first data input device is an image input device and the first data element is an image.

9. The system of claim 8 wherein the second data input device is an image input device and the second data element is an image.

10. The system of claim 8 wherein the second data input device is an audio input device and the second data element is audio data.

11. The system of claim 8 wherein the image input device is a photographic camera.

12. The system of claim 8 wherein the image input device is a video camera.

13. The system of claim 8 wherein the image input device is a scanner and the first data element is a scanned image.

14. The system of claim 1 wherein the first data input device is an audio input device and the first data element is audio data.

15. The system of claim 14 wherein the second data input device is an audio input device and the second data element is audio data.

16. The system of claim 14 wherein the second data input device is an image input device and the second data element is an image.

17. The system of claim 1, further comprising a trigger element to initiate the capture of the first and second data elements.

18. The system of claim 17 wherein the trigger element initiates the capture upon receipt of a trigger based on an event external to the system.

19. The system of claim 17 wherein the trigger element is periodically activated.

20. The system of claim 1 wherein at least the first data input device is configured to be worn by an individual user.

21. The system of claim 1 wherein at least the first data input device is a portable image input device and the first data element is an image.

22. The system of claim 21, further comprising a horizon adjustment system to detect a horizon within the image and to alter the captured first data element to position the horizon at a desired position within the altered image.

23. The system of claim 1 for use with a second system with each system having a clock, first and second data input devices, a processor and a data storage element, the system further comprising a communication controller to control communication between the systems, the communication controller permitting the access of the data storage element of the other system to thereby exchange data storage elements between the systems.

24. The system of claim 21 wherein the systems exchange data storage elements between the systems based on the time context associated with the stored data elements.

25. A relational database system comprising:
a storage device to store data elements;
an input interface to receive a plurality of multimedia data elements, each of the plurality of multimedia data elements having a time context, a date context and a place context associated therewith, the input interface storing the plurality multimedia data elements in the storage device in association with the time, date and place contexts;
a search interface configured to receive a search element and to locate all multimedia data elements within the storage device that are determined to be a match with the search element; and
an output interface to generate an output list of all multimedia data elements that match the search element.

26. The database system of claim 25 wherein the search element is the time context and the search interface locates all multimedia data elements that match the time context indicated by the search element.

27. The database system of claim 25 wherein the search element is the date context and the search interface locates all multimedia data elements that match the date context indicated by the search element.

28. The database system of claim 25 wherein the search element is the place context and the search interface locates all multimedia data elements that match the place context indicated by the search element.

29. The database system of claim 25 for use with a second database system wherein the search element is used by a search interface associated with the second database system to locate all multimedia data elements within a storage device associated with the second database system that are determined to match the search element.

30. A context-based data storage method comprising:
deriving a time context;
capturing a plurality of image and audio data elements;
associating each of the plurality of captured data elements with a respective time context; and
storing the plurality of data elements in association with the time context wherein the plurality of data elements are stored in association with each other based on the time context.

31. The method of claim 30, further comprising retrieving selected ones of the plurality of stored data elements based on the time context.

32. The method of claim 30, further comprising storing text data wherein the plurality of data elements are stored in relation to each other based on the text data.

33. The method of claim 30, further comprising deriving a date context wherein the plurality of data elements are stored in association with each other based on the date context.

34. The method of claim 30, further comprising using a position determination system to derive a position context wherein the plurality of data elements are stored in association with each other based on the position context.

35. The method of claim 30, further comprising deriving a date context and using a position determination system to derive a position context wherein the plurality of data elements are stored in association with each other based on the time, date and position contexts.

36. The method of claim 35, further comprising retrieving selected ones of the plurality of stored data elements based on a selected one of the time, date or position contexts.

37. The method of claim 35, further comprising retrieving selected ones of the plurality of stored data elements based on a selected two of the time, date or position contexts.

38. The method of claim 30 wherein a first of the plurality of data elements is an image.

39. The method of claim 38 wherein a second of the plurality of data element is an image.

40. The method of claim 38 wherein a second of the plurality of data elements is audio data.

41. The method of claim 30 wherein a first of the plurality of data elements is audio data.

42. The method of claim 41 wherein a second of the plurality of data elements is audio data.

43. The method of claim 42 wherein a second of the plurality of data element is an image.

44. The method of claim 30, further comprising automatically initiating the capture of the plurality of data elements automatically without user initiation.

45. The method of claim 30, further comprising sensing user activation of an input device to initiate the capture of the plurality of data elements.

46. The method of claim 30 wherein at least a first of the plurality of data elements is generated by a first input device worn by an individual user.

47. The method of claim 30 wherein at least a first of the plurality of data elements is generated by a portable imaging device, the first data element being an image.

48. The method of claim 47, further comprising detecting a horizon within the image and altering the image to position the horizon at a desired position within the altered image.

49. The method of claim 30, wherein the plurality of data elements are stored in a first database, the method further comprising storing additional data elements in a second database in association with each other based on the time context.

50. The method of claim 49, further comprising retrieving a data element stored in the second database on a user-selected time context and storing the retrieved data element in the first database.

51. A system for the collection and integration of life experience events, comprising:
an imaging data input device to capture an image data element;
an audio data input device to capture an audio data element;
a time circuit to provide a time and date;
a position determination system to provide position data;
a processor communicatively coupled to the time circuit and the position determination system to associate each of the first and second captured data elements with a respective time and date at which each of the image data and audio data elements were captured and to associate each of the first and second captured data elements with a position at which each of the image data and audio data elements were captured; and
a data storage element to store the first and second data elements in association with the time, date and position of capture.

52. The system of claim 51 wherein the data storage element is a relational database and the first and second data elements are stored in the database in relation to each other.

53. The system of claim 51 wherein the data storage element is a relational database, the system further comprising an input device to generate text data wherein data storage element stores the first and second data elements are stored in the data storage element in relation to each other based on the text data.

54. The system of claim 51 wherein the position determination system comprises a global positioning system (GPS) receiver.

55. The system of claim 51, further comprising a trigger element to initiate the capture of the first and second data elements.

56. The system of claim 55 wherein the trigger element initiates the capture upon receipt of a trigger based on an event external to the system.

57. The system of claim 55 wherein the trigger element is periodically activated.

58. The system of claim 55 wherein the imaging data input device and the audio data input device are configured in a portable device.

59. The system of claim 58 wherein the imaging data input device and the audio data input device are configured to be worn by an individual user.
